(19) United States
(12) Patent Application Publication
(10) Pub. No.: US 2026/0340388 A1
(43) Pub. Date: Oct. 29, 2026

(54) MANAGING GENERATIVE ARTIFICIAL INTELLIGENCE (AI) MODEL OUTPUTS USING UNINFERENCING COMPLIANT CONTEXTUAL INFORMATION

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/191,575

(22) Filed: Apr. 28, 2025

(51) Int. Cl. G06N 3/082; G06F 16/2455; G06N 3/0475

(52) U.S. Cl. CPC G06N 3/082; G06F 16/24556; G06N 3/0475

(57) ABSTRACT

Methods and systems for providing computer-implemented services using generative AI models are disclosed. To do so, a prompt for a generative AI model may be obtained from a user. The prompt may include a first portion of the prompt, and a second portion of the prompt. An embedding generation process may be performed using at least the prompt to obtain an aggregated embedding. A contextual information retrieval process may be performed using the aggregated embedding and a contextual information repository to obtain uninferencing compliant contextual information for the prompt. The prompt may be serviced using at least the uninferencing compliant contextual information and the generative AI model.

### FIELD

Embodiments disclosed herein relate generally to providing computer-implemented services using generative artificial intelligence (AI) models. More particularly, embodiments disclosed herein relate to managing generative AI model outputs using uninferencing compliant contextual information.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2B show flow diagrams illustrating data flows in accordance with an embodiment.

FIG. 3 shows a flow diagram illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs when provided with prompts. The outputs may be used, at least in part, to provide the computer-implemented services. For example, the outputs may be provided to a downstream consumer (e.g., a user) and the downstream consumer may use the outputs to make decisions.

The outputs may be provided to downstream consumers as part of chat sessions (e.g., generative AI sessions) with the downstream consumers. A chat session may include any exchange of prompts from a first entity (e.g., a downstream consumer) and outputs from a second entity (e.g., a generative AI model). For example, a chat session may be initiated by a downstream consumer (e.g., a client, a customer) via a graphical user interface (GUI). The downstream consumer may enter a prompt, which may be displayed in a chat window of the GUI. The prompt may be used as ingest for a generative AI model and the output generated by the generative AI model may be added to the chat window as a response from a chat agent (e.g., a virtual assistant). The downstream consumer may enter additional prompts during the chat session and all prompts and outputs may be recorded on the chat window during the chat session.

The generative AI model may include a retrieval-augmented generation (RAG) architecture, and portions of the prompt may be used to obtain contextual information for the prompt. The contextual information and the prompt may be used to generate an ingest package, and the ingest package may be used by the generative AI model to generate an output responsive to the prompt. The contextual information provided to the generative AI model as part of the ingest package may influence the output generated by the generative AI model. However, the contextual information obtained for the prompt may include information content that the downstream consumer does not desire to be used to generate the output. As a result, the output may not meet expectations of the downstream consumer. Consequently, computer-implemented services provided using the output may be negatively impacted. To improve a user's (e.g., a downstream consumer's) experience and increase a likelihood of providing outputs that meet expectations of the downstream consumer, uninferencing compliant contextual information may be obtained for the prompt based on user ascribed values for portions of the prompt. For example, the prompt may include a first portion having a positive user ascribed value, and a second portion having a negative user ascribed value. The positive user ascribed value may be ascribed to the first portion due to the first portion including an information content which the user desires to be used to generate an output for the prompt. The negative user ascribed value may be ascribed to the second portion due to the second portion including an information content which the user does not desire to be used to generate the output for the prompt. Using at least the prompt and based on the user ascribed values, an embedding generation process may be performed to obtain an aggregate embedding. During the embedding generation process, a positive embedding may be obtained for the first portion, and a negative embedding may be obtained for the second portion. The positive embedding and the negative embedding may be used to obtain the aggregated embedding (e.g., may be summed and/or otherwise combined).

The aggregate embedding may include an inference model-ingestible representation of the prompt based on the user ascribed values for the first portion of the prompt and the second portion of the prompt. Using the aggregated embedding, a contextual information retrieval process for the prompt may be performed (e.g., using a contextual information repository such as a RAG repository) to obtain uninferencing compliant contextual information to be used as context by the generative AI model for the prompt. The prompt may then be serviced by generating an output by the generative AI model using at least the uninferencing compliant contextual information and the prompt. The output may be used to provide computer-implemented services to the downstream consumer.

Thus, embodiments disclosed herein may provide an improved method for providing computer-implemented services using generative AI models. To provide the computer-implemented services as desired by downstream consumers, uninferencing compliant contextual information for a prompt may be obtained based on user ascribed values for portions of the prompt. Doing so may increase a likelihood that outputs generated as part of the chat session are accurate and relevant to the needs of the downstream consumer.

In an embodiment, a method for providing computer-implemented services using generative AI models is provided. The method may include: obtaining, from a user, a prompt for a generative AI model of the generative AI models, the prompt including: a first portion of the prompt, and a second portion of the prompt; performing, using at least the prompt, an embedding generation process to obtain an aggregated embedding, the aggregated embedding including an inference model-ingestible representation of the prompt based on user ascribed values for the first portion of the prompt and the second portion of the prompt; performing, using the aggregated embedding and a contextual information repository, a contextual information retrieval process to obtain uninferencing compliant contextual information for the prompt; and servicing the prompt using at least the uninferencing compliant contextual information and the generative AI model.

The first portion of the prompt may be ascribed a positive user ascribed value by the user, and the second portion of the prompt may be ascribed a negative user ascribed value by the user.

Performing the embedding generation process may include: obtaining a positive embedding for the first portion of the prompt; obtaining a negative embedding for the second portion of the prompt; and using the positive embedding and the negative embedding to obtain the aggregated embedding.

Obtaining the negative embedding for the second portion of the prompt may include: obtaining a second positive embedding for the second portion of the prompt; and negating the second positive embedding to obtain the negative embedding.

Performing the contextual information retrieval process may include: identifying data sources from the contextual information repository that are similar to the positive embedding based on similarity criteria; ranking the data sources based on similarity to the positive embedding to obtain a first ranking of the data sources; reranking the data sources based on similarity to the negative embedding to obtain a second ranking of the data sources; and selecting at least one data source to be used as the uninferencing compliant contextual information based on at least the second ranking of the data sources.

Performing the contextual information process may include: identifying data sources from the contextual information repository that are similar to the aggregate embedding based on similarity criteria; ranking the data sources based on similarity to the aggregate embedding to obtain a ranking; and selecting at least one data source to be used as the uninferencing compliant contextual information based on at least the ranking.

Servicing the prompt may include: obtaining, using the prompt and the uninferencing compliant contextual information, an ingest package for the generative AI model; initiating generation of an output by the generative AI model using the ingest package; and using the output to provide the computer-implemented services to the user.

Initiating generation of the output by the generative AI model may include: performing, using the second portion of the prompt, an un-inferencing process to obtain a temporarily updated instance of the generative AI model, the second portion of the prompt being ascribed a negative user ascribed value by the user, and the temporarily updated instance of the generative AI model being less influenced by the second portion than the generative AI model.

Performing the un-inferencing process may include at least one action selected from a list of actions consisting of: negating embeddings corresponding to the second portion of the prompt to obtain the temporarily updated instance of the generative AI model; adding, based on the second portion of the prompt, a negation layer to an input layer of the generative AI model to obtain the temporarily updated instance of the generative AI model; adding, based on the second portion of the prompt, the negation layer prior to an attention module of the generative AI model to obtain the temporarily updated instance of the generative AI model; and adding, based on the second portion of the prompt, the negation layer to a hidden layer of the attention module to obtain the temporarily updated instance of the generative AI model.

Obtaining the prompt may include: obtaining, from the user, the prompt as part of a chat session via interactions between the user and a graphical user interface (GUI).

A record of the chat session may be displayed to the user via the GUI. The record of the chat session may include the prompt and any outputs generated by the generative AI model during the chat session.

The generative AI model may be a large language model (LLM).

The prompt may include at least one type of data modality selected from a list of types of data modalities consisting of: (i) text, (ii) image, (iii) video, and (iv) audio.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

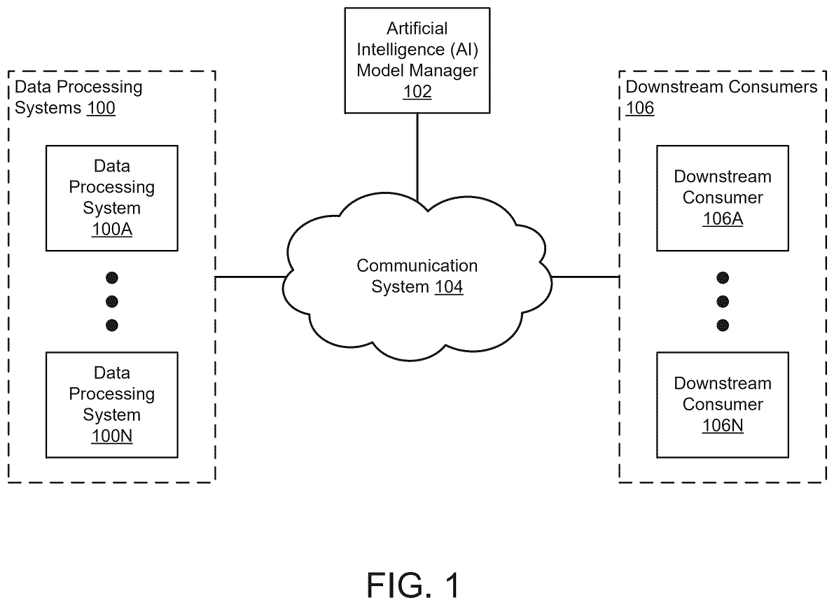

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with prompts (e.g., ingest data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems, users of client devices and/or data processing systems) as part of providing the computer-implemented services.

The outputs may be provided to downstream consumers 106 as part of generative AI sessions (e.g., chat sessions) with downstream consumers 106. A chat session may include, for example, a real-time interaction between two entities (e.g., a downstream consumer such as a user of a client device and an AI agent) during which information is exchanged. The information may include prompts provided by the downstream consumer and outputs generated by a generative AI model. The prompts and the outputs may include any type of data modality (e.g., images, audio, video, text).

A chat session may be accessed by a downstream consumer (e.g., 106A) via a graphical user interface (GUI) used as part of, for example, a customer support service, a data analysis service, a content creation service, and/or other services. Downstream consumer 106A may provide a prompt and the AI agent may provide an output that is responsive to the prompt. The AI agent may include a software program that manages, at least in part, operation of the generative AI model and that serves as a proxy for the generative AI model in a simulated conversation with downstream consumer 106A during the chat session.

The generative AI model may include a retrieval-augmented generation (RAG) architecture, and portions of the prompt may be used to obtain contextual information for the prompt. The contextual information and the prompt may be used to generate an ingest package, and the ingest package may be used by the generative AI model to generate an output responsive to the prompt. The contextual information provided to the generative AI model as part of the ingest package may influence the output generated by the generative AI model.

However, the contextual information obtained for the prompt may include information content that downstream consumer 106A does not desire to be used to generate the output. As a result, the output may not meet expectations of downstream consumer 106A. Consequently, computer-implemented services provided using the output may be negatively impacted. In general, embodiments disclosed herein may provide methods, systems, and/or devices for servicing a prompt obtained from a user (e.g., a downstream consumer) using uninferencing compliant contextual information as part of an ingest package for a generative AI model. The uninferencing compliant contextual information may be obtained based on user ascribed values for portions of the prompt, which may indicate user sentiments regarding the portions of the prompt. The prompt and/or user ascribed values for portions of the prompt may be obtained from the user as part of a chat session via interactions between the user and a GUI.

The prompt may include, for example: (i) a first portion, the first portion being ascribed a positive user ascribed value by the user, and (ii) a second portion, the second portion being ascribed a negative user ascribed value by the user. The positive user ascribed value may indicate that the user desires information content of the first portion of the prompt to impact an output obtained using the prompt, and the negative user ascribed value may indicate that the user does not desire information content of the second portion of the prompt to impact the output obtained using the prompt.

Using the prompt, an embedding generation process may be performed to obtain an aggregated embedding based on the user ascribed values for the portions of the prompt. For example, the embedding generation process may include: (i) obtaining a positive embedding for the first portion of the prompt, (ii) obtaining a negative embedding for the second portion of the prompt, and/or (iii) using the positive embedding and the negative embedding to obtain the aggregated embedding (e.g., summing the positive embedding and the negative embedding, and/or otherwise combining the embeddings using any function or method).

The aggregated embedding may then be used to obtain the uninferencing compliant contextual information for the prompt (e.g., from a contextual information repository such as a RAG repository). An ingest package for the generative AI model may be generated, the ingest package including the uninferencing compliant contextual information and the prompt. Generation of the output may be initiated using the ingest package (e.g., by feeding the ingest package into the generative AI model as input). The output may then be used to provide the computer-implemented services to the user.

Thus, embodiments disclosed herein may improve processes of providing outputs generated by generative AI models to downstream consumers of the outputs (e.g., users). By obtaining uninferencing compliant contextual information for a prompt (e.g., contextual information for an aggregated embedding of portions of the prompt based on user ascribed values), outputs may be generated with a reduced influence of undesired portions of prompts. Consequently, a likelihood of providing desired computer-implemented services may be increased.

To provide the above noted functionality, the system of FIG. 1 may include data processing systems 100, AI model manager 102, downstream consumers 106, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from users such as clients, owners of downstream consumer 106A, employees of a company that owns downstream consumer 106A) to data processing system 100A as part of the subscribed services.

As part of providing the computer-implemented services, data processing systems 100 may: (i) obtain ingest packages (e.g., prompts, contextual information for the prompts) for generative AI models (e.g., hosted and/or operated by data processing systems 100), (ii) feed the ingest packages into a generative AI model to obtain outputs, and (iii) provide the outputs to downstream consumers as part of providing computer-implemented services to the downstream consumers.

Data processing systems 100 may provide chat session services to downstream consumers 106. For example, one or more of downstream consumers 106 may host AI agents that manage chat sessions with users (e.g., downstream consumers). A record of the chat sessions may be displayed, via the GUI, on a user's device (e.g., one or more of downstream consumers 106).

As part of providing the computer-implemented services, data processing systems 100 may also: (i) obtain, from a user (e.g., downstream consumer 106A), a prompt for a generative AI model, (ii) obtain user ascribed values for portions of the prompt, (iii) perform, using at least the prompt, an embedding generation process to obtain an aggregated embedding based on the user ascribed values, (iv) perform, using the aggregated embedding and a contextual information repository, a contextual information retrieval process for the prompt to obtain uninferencing compliant contextual information for the prompt, (v) service the prompt using at least the uninferencing compliant contextual information and the generative AI model, and/or (vi) perform other actions.

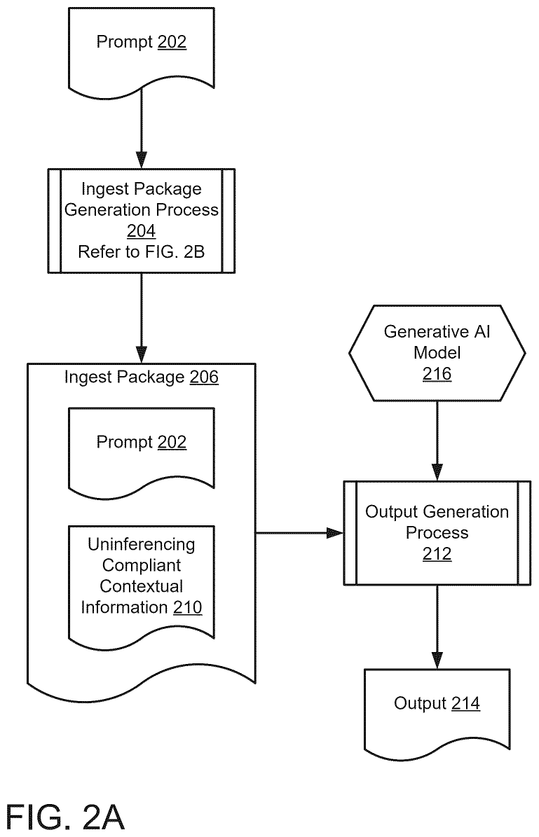

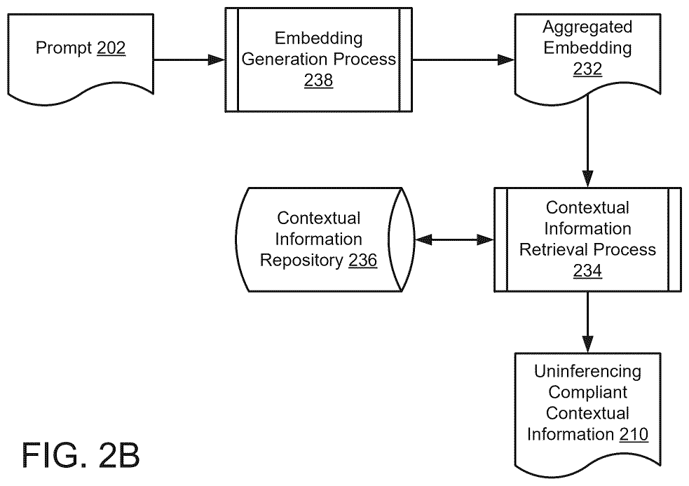

Refer to FIG. 2A for additional details regarding obtaining the prompt and servicing the prompt. Refer to FIG. 2B for additional details regarding performing the embedding generation process and performing the contextual information retrieval process.

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs as part of receiving the computer-implemented services.

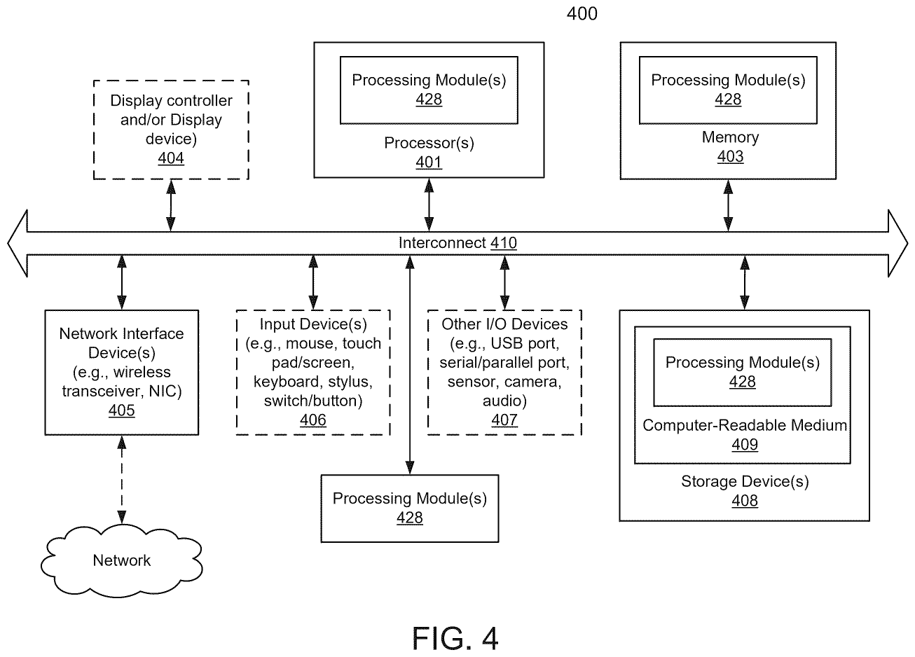

Any of (and/or components thereof) data processing systems 100, AI model manager 102, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

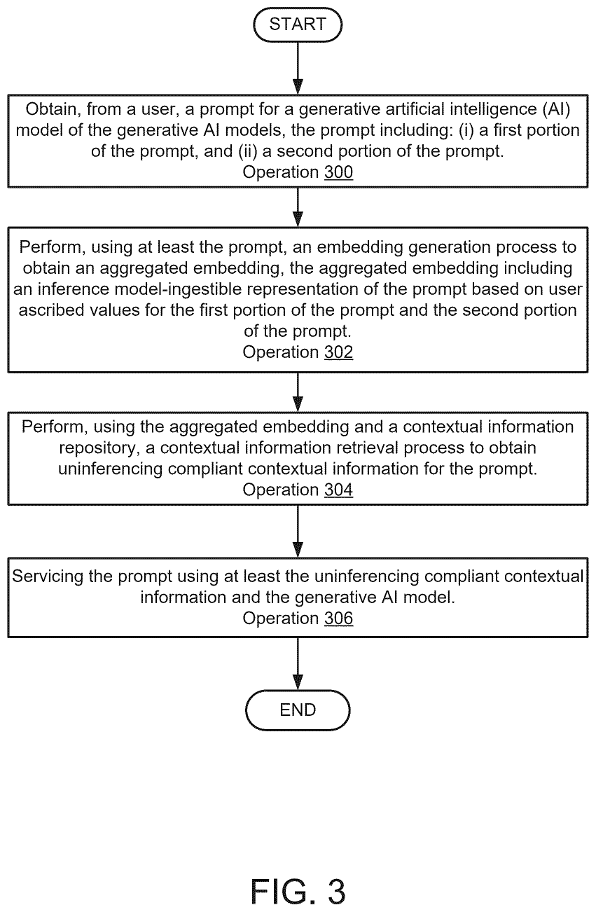

While providing their functionality, any of data processing systems 100, AI model manager 102, and/or downstream consumers 106 may provide all or a portion of the methods shown in FIGS. 2A-3.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 200, 214, etc.) is used to represent data structures, a second set of shapes (e.g., 204, 212 etc.) is used to represent processes performed using and/or that generate data, a third set of shapes (e.g., 216) is used to represent generative AI models and/or other types of models, and a fourth set of shapes (e.g., 236) is used to represent large scale data structures such as databases.

Turning to FIG. 2A, a first data flow diagram in accordance with an embodiment is shown. The first data flow diagram may illustrate data used in and data processing performed in providing computer-implemented services using at least an output generated by a generative AI model.

As part of providing the computer-implemented services, a user (e.g., downstream consumer 106A) may initiate a chat session (e.g., with an AI agent hosted by one or more of downstream consumers 106). During the chat session, the user may provide prompt 202. Prompt 202 may be provided, by the user, via an interaction with a graphical user interface (GUI). The GUI may display, to the user, a record of the chat session that includes: (i) prompts provided by the user during the chat session (e.g., including prompt 202), and/or (ii) outputs generated by generative AI model 216 during the chat session.

Prompt 202 may include a query for generative AI model 216, and may include any type of data modality (e.g., images, audio, video, text). For example, prompt 202 may include: (i) a first portion, and (ii) a second portion. The first portion of prompt 202 may be ascribed a positive user ascribed value, and the second portion of prompt 202 may be ascribed a negative user ascribed value. The positive user ascribed value may indicate an information content which the user desires to be included in an output generated based on prompt 202. The negative user ascribed value may indicate an information content which: (i) the user does not desire to be included in the output generated based on prompt 202, (ii) is associated with the information content the user does not desire to be included in the output generated based on prompt 202, and/or (iii) is otherwise deemed undesirable by the user.

The user ascribed values for the portions of prompt 202 may be obtained by: (i) analyzing words, phrases, and/or other indicators provided by the user as part of prompt 202 (e.g., by an LLM), (ii) including functionality as part of the GUI for the user to enter the user ascribed values (e.g., via the user highlighting the portions of prompt 202 and selecting a button on the GUI to indicate a user ascribed value for the highlighted portions), and/or (iii) via other methods. For example, the user may ascribe a negative user ascribed value to the second portion of the prompt by including words such as “not,” “excluding,” “unrelated to,” etc. The user ascribed values may be obtained via any other method without departing from embodiments disclosed herein.

For example, the user may be a researcher seeking information regarding a disease (e.g., disease A) from the generative AI model. Concepts regarding the disease may have evolved over time, and the researcher may desire that a first concept regarding the disease is not included in the information provided by the generative AI model (e.g., due to being outdated, disproven, and/or otherwise undesired by the researcher). For example, the first concept may include the role of a protein (e.g., protein B) in progression of the disease, which research has since disproven. During the chat session, the researcher may provide prompt 202 to the AI agent including the text: “provide me information about disease A, excluding information related to the role of protein B in the progression of disease A.” In this example, the first portion of prompt 202 having the positive user ascribed value may include the text “disease A,” and the second portion of prompt 202 having the negative user ascribed value may include the text “the role of protein B in the progression of disease A.”

Using prompt 202 and the user ascribed values for the portions of prompt 202, ingest package generation process 204 may be performed to obtain ingest package 206. Ingest package 206 may include: (i) prompt 202, and (ii) contextual information for prompt 202 (e.g., uninferencing compliant contextual information 210). Obtaining ingest package 206 may be performed as part of a retrieval-augmented generation (RAG) process. During ingest package generation process 204, uninferencing compliant contextual information 210 may be obtained for prompt 202. To obtain uninferencing compliant contextual information 210 during ingest package generation process 204, an embedding generation process may be performed using at least prompt 202 to obtain an aggregated embedding. The aggregated embedding and a contextual information repository may be used to perform a contextual information retrieval process to obtain uninferencing compliant contextual information 210. Uninferencing compliant contextual information may include data sources and/or other information which is usable to provide context for prompt 202 based on the aggregated embedding. Refer to the description of FIG. 2B for additional details regarding ingest package generation process 204.

Using ingest package 206, output generation process 212 may be performed to service prompt 202. During output generation process 212, generation of output 214 by generative AI model 216 may be initiated by feeding ingest package 206 into generative AI model 216.

Generative AI model 216 may be an LLM (e.g., a neural network inference model) trained to generate language, understand language, and/or otherwise process requests related to languages. Generative AI model 216 may have been previously trained using training data and any training process (e.g., a global optimization process using gradient descent), the training data indicating goals for outputs generated by generative AI model 216 (e.g., outputs). Parameters of generative AI model 216 may be selected using an optimization process (e.g., an objective function may be defined in terms of the training data and outputs generated by generative AI model 216, and a global optimization method such as gradient descent may be used to identify parameters that most faithfully reproduce the trends in the training data). Once the parameters of generative AI model 216 are set, then generative AI model 216 may be used to generate outputs (e.g., responses) based on input data (e.g., ingest packages). Generative AI model 216 may be trained using other methods without departing from embodiments disclosed herein.

Generative AI model 216 may generate output 214 using ingest package 206. An AI agent (e.g., a software program) may retrieve output 214 and may populate a chat window on the GUI using output 214 as part of the chat session.

By using uninferencing compliant contextual information 210 to provide context to generate output 214, the contextual information used by generative AI model 216 may have an increased likelihood of eliciting output 214 which meets the expectations of the user. Output 214 may then be used to provide the computer-implemented services to the user.

Returning to the above example, uninferencing compliant contextual information may be obtained for the prompt “provide me information about disease A, excluding information related to the role of protein B in the progression of disease A.” The uninferencing compliant contextual information may include data chunks from research articles, and/or other documents regarding disease A that do not include information regarding the role of protein B in the progression of disease A. By doing so, relevant contextual information may be obtained for the prompt. The prompt (e.g., “provide me information about disease A, excluding information related to the role of protein B in the progression of disease A”) and the uninferencing compliant contextual information may be provided to generative AI model 216, and an output may be generated which meets the expectations of the researcher

Turning to FIG. 2B, a second data flow diagram in accordance with an embodiment is shown. The second data flow diagram may illustrate data used in and data processing performed in obtaining uninferencing compliant contextual information (e.g., 210) to be used as part of an ingest package (e.g., 206 shown in FIG. 2A) for a generative AI model to generate an output.

To obtain uninferencing compliant contextual information 210, embedding generation process 238 may be performed. During embedding generation process 238, prompt 202 may be used to obtain aggregated embedding 232. For additional details regarding prompt 202, refer to the description of FIG. 2A.

Aggregated embedding 232 may include an inference model-ingestible representation of prompt 202 based on user ascribed values for portions of prompt 202. For example, aggregated embedding 232 may include a numerical representation (e.g., a mathematical object such as a vector) of text of prompt 202 that represents a meaning and context of the text. Aggregated embedding 232 may be usable to obtain uninferencing compliant contextual information 210 for the prompt 202.

To obtain aggregated embedding 232 during embedding generation process 238, an embedding may be obtained for each portion of prompt 202 based on the user ascribed values. A positive embedding may be obtained for portions of prompt 202 ascribed a positive user ascribed value, and a negative embedding may be obtained for portions of prompt 202 ascribed a negative user ascribed value.

For example, as discussed above, prompt 202 may include a first portion ascribed a positive user ascribed value, and a second portion ascribed a negative ascribed value. Therefore, a positive embedding may be obtained for the first portion, and a negative embedding may be obtained for the second portion.

Obtaining the positive embedding for the first portion may include generating the positive embedding using the first portion and any function and/or method usable to convert text (and/or other data modalities) into numerical vectors (e.g., a transformer model).

Obtaining the negative embedding for the second portion may include generating a second positive embedding for the second portion (e.g., via similar methods to those described with respect to generating the positive embedding for the first portion). The second positive embedding for the second portion may then be negated to obtain the negative embedding. Negating the second positive embedding may include using any method and/or mathematical function, such as multiplying components of the second positive embedding by −1. For example, the second positive embedding may include the components <1, −2, −3>, and negating the second positive embedding may generate the negative embedding <−1, 2, 3>.

The positive embedding for the first portion of prompt 202 and the negative embedding for the second portion of prompt 202 may be used to obtain aggregated embedding 232. Aggregated embedding 232 may include the positive embedding and the negative embedding, and/or may include a combined embedding representing both the positive embedding and the negative embedding. To obtain aggregated embedding 232, any method and/or function may be used. For example, components of the positive embedding and components of the negative embedding may be summed and/or compiled to generate aggregated embedding 232. By doing so, a contribution of the second portion of prompt 202 to the embedding for prompt 202 may be reduced. Other methods may be used to obtain aggregated embedding 232 without departing from embodiments disclosed herein.

Returning to the example discussed in FIG. 2A, the researcher may provide the prompt “provide me information about disease A, excluding information related to the role of protein B in the progression of disease A.” The prompt may include a first portion having a positive user ascribed value, “disease A,” and a second portion having a negative user ascribed value, “the role of protein B in the progression of disease A.” Using the prompt and the user input, two embeddings may be generated: (i) a positive embedding for “disease A,” and (ii) a negative embedding for “the role of protein B in the progression of disease A.” The two embeddings may be summed (and/or otherwise used) to obtain aggregated embedding 232.

Aggregated embedding 232 may be used to perform contextual information retrieval process 234 to obtain uninferencing compliant contextual information 210. During contextual information retrieval process 234, aggregated embedding 232 may be used to identify contextual information from contextual information repository 236. Contextual information repository 236 may include a database, such as a RAG repository, which may include data sources which may be relevant to prompts provided to generative AI models.

During contextual information retrieval process 234, uninferencing compliant contextual information 210 may be obtained by identifying data sources from contextual information repository 236 that are similar to the positive embedding. To do so, a similarity analysis may be performed to identify the data sources (e.g., embedding representations of the data sources) which are similar to the positive embedding based on similarity criteria. The similarity criteria may include any similarity criteria, such as a threshold level of similarity, and may be obtained from a subject matter expert and/or any other source. The data sources that were identified may be ranked based on similarity to the positive embedding (e.g., from most similar to the positive embedding to least similar to the positive embedding) to obtain a first ranking of the data sources. The data sources may then be reranked based on similarity to the negative embedding to obtain a second ranking. For example, a data source may become lower ranked (e.g., demoted in the second ranking) by being similar to the negative embedding. At least one data source may then be selected based on at least the second ranking of the data sources, and may be used as uninferencing compliant contextual information 210.

Returning to the above example, data sources from contextual information repository 236 may be identified that are similar to the positive embedding for “disease A.” The data sources may be ranked from most similar to the positive embedding to least similar to the positive embedding. The data sources may then be compared to the negative embedding for “the role of protein B in the progression of disease A” and may be reranked. For example, a research article may meet similarity criteria for the positive embedding by including information regarding disease A. However, the research article may include information regarding the role of protein B in the progression of disease A, and may therefore be similar to the negative embedding. As a result, the research article may be demoted in the ranking, and may not be used as uninferencing compliant contextual information for the prompt.

During contextual information retrieval process 234, uninferencing compliant contextual information 210 may also be obtained by identifying data sources from contextual information repository 236 that are similar to aggregate embedding 232 based on similarity criteria. The similarity criteria may include any similarity criteria, such as a threshold level of similarity, and may be obtained from a subject matter expert and/or any other source (e.g., the similarity criteria may be the same or different from the similarity criteria discussed above). The data sources that were identified may be ranked based on similarity to aggregate embedding 232 (e.g., from most similar to aggregate embedding 232 to least similar to aggregate embedding 232) to obtain a ranking. At least one data source may be selected based on at least the ranking and used as uninferencing compliant contextual information 210.

Returning to the above example, data sources from contextual information repository 236 may be identified that are similar to the aggregate embedding for “provide me information about disease A, excluding information related to the role of protein B in the progression of disease A.” The aggregate embedding may include a sum of the positive embedding for “disease A” and the negative embedding for “the role of protein B in the progression of disease A.” The data sources may be ranked from most similar to the aggregate embedding to least similar to the aggregate embedding. At least one data source may be selected based on the ranking and used as uninferencing compliant contextual information for the prompt.

Uninferencing compliant contextual information 210 may then be used as part of ingest package 206 (shown in FIG. 2A) for the generative AI model to generate an output.

Thus, by implementing the data flows shown in FIGS. 2A-2B, a system in accordance with embodiments disclosed herein may be used to obtain uninferencing compliant contextual information for a prompt based on user ascribed values for portions of the prompt. The uninferencing compliant contextual information may be used as part of an ingest package for a generative AI model. By doing so, a likelihood that an output may be obtained by a user which meets expectations of the user may be improved. Consequently, a reliability and/or usefulness of the output may be increased for the user.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage a data processing system. FIG. 3 illustrates methods that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing computer-implemented services using generative AI models in accordance with an embodiment is shown. The method may be performed, for example, by any of the components of the system of FIG. 1, and/or other components not shown therein.

At operation 300, a prompt for a generative artificial intelligence (AI) model of the generative AI models may be obtained from a user, the prompt including: (i) a first portion of the prompt, and (ii) a second portion of the prompt. Obtaining the prompt may include: (i) obtaining, from the user, the prompt as part of a chat session via interactions between the user and a GUI, (ii) reading the prompt from storage, (iii) receiving the prompt from another entity via a communication system, and/or other methods.

Obtaining the prompt as part of the chat session may include receiving the prompt from the user as input into the GUI using any number of human interface devices operably connected to a device operated by the user. For example, obtaining the prompt may include: (i) obtaining the prompt as text from the user using a keyboard, (ii) obtaining the prompt from the user via a voice to text feature using a microphone, and/or (iii) other methods.

At operation 302, an embedding generation process may be performed using at least the prompt to obtain an aggregated embedding, the aggregated embedding including an inference model-ingestible representation of the prompt based on user ascribed values for the first portion of the prompt and the second portion of the prompt. Performing the embedding generation process may include: (i) obtaining a positive user ascribed value for the first portion of the prompt and a negative user ascribed value of the second portion of the prompt, (ii) obtaining a positive embedding for the first portion of the prompt, (iii) obtaining a negative embedding for the second portion of the prompt, (iv) using the positive embedding and the negative embedding to obtain the aggregated embedding, (v) providing the at least the prompt and the user ascribed values to another entity responsible for performing the embedding generation process and receiving the aggregated embedding in response, and/or (vi) other methods.

Obtaining the positive user ascribed value for the first portion of the prompt and the negative user ascribed value of the second portion of the prompt may include: (i) analyzing text included in the prompt to identify the positive user ascribed value and the negative user ascribed value (e.g., via any analysis method, using an LLM), (ii) prompting the user to provide the positive user ascribed value and the negative user ascribed value and receiving the positive user ascribed value and the negative user ascribed value in response (e.g., via selecting a button on the GUI corresponding to the desired user ascribed value), (iii) reading the positive user ascribed value and the negative user ascribed value from storage, (iv) receiving the positive user ascribed value and the negative user ascribed value from another entity, and/or (v) other methods.

Obtaining the positive embedding may include: (i) generating the positive embedding using the first portion and any function and/or method usable to convert the first portion into a numerical vector (e.g., generating an embedding layer after using a tokenizer), (ii) reading the positive embedding from storage, (iii) receiving the positive embedding from another entity, and/or (iv) other methods.

Obtaining the negative embedding may include: (i) obtaining a second positive embedding for the second portion of the prompt (e.g., generating the second positive embedding using the second portion of the prompt and any function and/or method usable to convert the second portion into a numerical vector, reading the second positive embedding from storage, receiving the second positive embedding from another entity), (ii) negating the second positive embedding to obtain the negative embedding (e.g., performing a mathematical operation to negate the second positive embedding, such as multiplying the second positive embedding by −1, providing the second positive embedding to another entity responsible for negating the second positive embedding and receiving the negative embedding in response), (ii) reading the negative embedding from storage, (iii) receiving the negative embedding from another entity, and/or (iv) other methods.

Using the positive embedding and the negative embedding to obtain the aggregated embedding may include: (i) using any number and type of mathematical functions to obtain (e.g., calculate) the aggregated embedding using the positive embedding and the negative embedding (e.g., summing the positive embedding and the negative embedding), (ii) providing the positive embedding and the negative embedding to another entity responsible for generating the aggregated embedding and receiving the aggregated embedding in response, (iii) compiling the positive embedding and the negative embedding into a data structure and using the data structure as the aggregate embedding, and/or (iv) other methods.

At operation 304, a contextual information retrieval process may be performed using the aggregated embedding and a contextual information repository to obtain uninferencing compliant contextual information for the prompt. Performing the contextual information retrieval process may include: (i) identifying data sources from the contextual information repository that are similar to the positive embedding based on similarity criteria, (ii) ranking the data sources based on similarity to the positive embedding to obtain a first ranking of the data sources, (iii) reranking the data sources based on similarity to the negative embedding to obtain a second ranking of the data sources, (iv) selecting at least one data source to be used as the uninferencing compliant contextual information based on at least the second ranking of the data sources, and/or (v) other methods.

Identifying the data sources from the contextual information repository that are similar to the positive embedding based on similarity criteria may include: (i) obtaining the similarity criteria (e.g., receiving the similarity criteria from a subject matter expert, reading the similarity criteria from storage, receiving the similarity criteria from another entity, generating the similarity criteria), (ii) comparing a value of the positive embedding to values of data sources from the contextual information repository to identify the data sources that meet the similarity criteria, and/or (iii) other methods.

Ranking the data sources based on similarity to the positive embedding to obtain the first ranking of the data sources may include: (i) assigning each of the data sources a similarity score, the similarity score indicating a degree of similarity between each of the data sources and the positive embedding, (ii) ordering the data sources based on similarity score (e.g., from a highest similarity score to a lowest similarity score) to obtain the first ranking, and/or (iii) other methods.

Reranking the data sources based on similarity to the negative embedding to obtain a second ranking of the data sources may include: (i) assigning each of the data sources a second similarity score, the second similarity score indicating a degree of similarity between each of the data sources and the negative embedding, (ii) reordering the data sources based on the second similarity score (e.g., from a lowest second similarity score to a highest second similarity score) to obtain a second ranking, and/or (iii) other methods. For example, reranking the data sources based on the second similarity score may include demoting data sources which are similar to the negative embedding.

Selecting at least one data source to be used as the uninferencing compliant contextual information based on at least the second ranking of the data sources may include: (i) identifying the at least one data source based on at least the second ranking and any criteria and/or thresholds for selecting data sources for use as the uninferencing compliant contextual information (e.g., based on a threshold quantity of data sources needed to provide sufficient context for the prompt), (ii) using the at least one data source as the uninferencing compliant contextual information, and/or (iii) other methods.

Performing the contextual information retrieval process may also include: (i) identifying data sources from the contextual information repository that are similar to the aggregate embedding based on similarity criteria, (ii) ranking the data sources based on similarity to the aggregate embedding to obtain a ranking, (iii) selecting at least one data source to be used as the uninferencing compliant contextual information based on at least the ranking.

Identifying data sources from the contextual information repository that are similar to the aggregate embedding based on similarity criteria may include: (i) obtaining the similarity criteria (e.g., receiving the similarity criteria from a subject matter expert, reading the similarity criteria from storage, receiving the similarity criteria from another entity, generating the similarity criteria), (ii) comparing a value of the aggregate embedding to values of data sources from the contextual information repository to identify the data sources that meet the similarity criteria, and/or (iii) other methods.

Ranking the data sources based on similarity to the aggregate embedding to obtain the ranking may include: (i) assigning each of the data sources a similarity score, the similarity score indicating a degree of similarity between each of the data sources and the aggregate embedding, (ii) ordering the data sources based on similarity score (e.g., from a highest similarity score to a lowest similarity score) to obtain the ranking, and/or (iii) other methods.

Selecting at least one data source to be used as the uninferencing compliant contextual information based on at least the ranking of the data sources may include: (i) identifying the at least one data source based on at least the ranking and any criteria and/or thresholds for selecting data sources for use as the uninferencing compliant contextual information (e.g., based on a threshold quantity of data sources needed to provide sufficient context for the prompt), (ii) using the at least one data source as the uninferencing compliant contextual information, and/or (iii) other methods.

At operation 306, the prompt may be serviced using at least the uninferencing compliant contextual information and the generative AI model. Servicing the prompt may include: (i) obtaining, using the prompt and the uninferencing compliant contextual information, an ingest package for the generative AI model, (ii) initiating generation of an output by the generative AI model using the ingest package, (iii) using the output to provide the computer-implemented services to the user, and/or (iv) other methods.

Obtaining the ingest package may include: (i) generating the ingest package (e.g., compiling the prompt and the uninferencing compliant contextual information into a data structure), (ii) providing the prompt and the uninferencing compliant contextual information to another entity responsible for generating the ingest package, (iii) reading the ingest package from storage, and/or (iv) other methods.

Initiating generation of the output by the generative AI model may include: (i) providing the ingest package to an entity responsible for hosting and operating the generative AI model, (ii) feeding the ingest package into the generative AI model and obtaining a response as output from the generative AI model, and/or (iii) other methods.

Initiating generation of the output by the generative AI model may also include performing, using the second portion of the prompt, an un-inferencing process to obtain a temporarily updated instance of the generative AI model, the second portion of the prompt being ascribed a negative user ascribed value by the user, and the temporarily updated instance of the generative AI model being less influenced by the second portion than the generative AI model.

Performing the un-inferencing process may include at least one action selected from a list of actions consisting of: (i) negating embeddings corresponding to the second portion of the prompt to obtain the temporarily updated instance of the generative AI model, (ii) adding, based on the second portion of the prompt, a negation layer to an input layer of the generative AI model to obtain the temporarily updated instance of the generative AI model, (iii) adding, based on the second portion of the prompt, the negation layer prior to an attention module of the generative AI model to obtain the temporarily updated instance of the generative AI model, (iv) adding, based on the second portion of the prompt, the negation layer to a hidden layer of the attention module to obtain the temporarily updated instance of the generative AI model, and (v) removing (e.g., deleting) tokens that correspond to the second portion of the prompt from a memory (e.g., attention) of the generative AI model.

Negating the embeddings may include: (i) obtaining the embeddings corresponding to the second portion (e.g., reading the embeddings from storage, obtaining the embeddings from another entity), (ii) multiplying each embedding by its corresponding un-inferencing weight and by negative one to flip a sign of the embedding, and/or (iii) other methods.

Adding the negation layer to the generative AI model may include: (i) identifying elements (e.g., neurons) of an input layer of the generative AI model that consume the second portion, (ii) performing an operation to modify a latent representation of the second portion prior to or following ingestion by the neurons of the input layer, and/or (iii) other methods. Modifying the latent representation may include changing attention values of the input (e.g., multiplying the attention values by negative one and the corresponding un-inferencing weights). By doing so, the second portion may be processed in a negated form (e.g., by the input layer, by a layer of neurons after the input layer).

Adding the negation layer (e.g., a layer that performs the modification of the information content) that feeds into the attention module may include methods similar to those described with respect to adding the negation layer to the input layer. However, the negation layer may be added to elements of the generative AI model that are located prior to an attention module of the generative AI model rather than in the input layer. Therefore, partially processed input data may pass through the negation layer prior to entering the attention module (e.g., attention layer) and/or after exiting the attention module.

Adding the negation layer to the hidden layer of the attention module may include methods similar to those described with respect to adding the negation layer to the input layer. However, the negation layer may be added within a hidden layer of the attention module rather than to the input layer. Therefore, partially processed input data may enter the attention module, pass through the negation layer at some point within the attention module, and may exit the attention module having passed through the negation layer.

Using the output to provide the computer-implemented services may include: (i) populating the GUI with at least the output (e.g., as part of a chat session), (ii) making decisions based on at least the output, (iii) providing the output to another entity, (iv) selecting one or more actions based on the output and performing the one or more actions to update operation of a system, and/or (v) other methods.

The method may end following operation 306.

Thus, as illustrated above, embodiments disclosed herein may provide systems and methods usable to provide computer-implemented services using generative AI models. By obtaining uninferencing compliant contextual information to provide context to a prompt based on user ascribed values for portions of the prompt, a likelihood of generating an output which meets the expectations of a user may be improved.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using generative artificial intelligence (AI) models, the method comprising:
obtaining, from a user, a prompt for a generative AI model of the generative AI models, the prompt comprising:
a first portion of the prompt, and
a second portion of the prompt;
performing, using at least the prompt, an embedding generation process to obtain an aggregated embedding, the aggregated embedding comprising an inference model-ingestible representation of the prompt based on user ascribed values for the first portion of the prompt and the second portion of the prompt;
performing, using the aggregated embedding and a contextual information repository, a contextual information retrieval process to obtain uninferencing compliant contextual information for the prompt; and
servicing the prompt using at least the uninferencing compliant contextual information and the generative AI model.

2. The method of claim 1, wherein the first portion of the prompt is ascribed a positive user ascribed value by the user, and the second portion of the prompt is ascribed a negative user ascribed value by the user.

3. The method of claim 2, wherein performing the embedding generation process comprises:
obtaining a positive embedding for the first portion of the prompt;
obtaining a negative embedding for the second portion of the prompt; and
using the positive embedding and the negative embedding to obtain the aggregated embedding.

4. The method of claim 3, wherein obtaining the negative embedding for the second portion of the prompt comprises:
obtaining a second positive embedding for the second portion of the prompt; and
negating the second positive embedding to obtain the negative embedding.

5. The method of claim 3, wherein performing the contextual information retrieval process comprises:
identifying data sources from the contextual information repository that are similar to the positive embedding based on similarity criteria;
ranking the data sources based on similarity to the positive embedding to obtain a first ranking of the data sources;
reranking the data sources based on similarity to the negative embedding to obtain a second ranking of the data sources; and
selecting at least one data source to be used as the uninferencing compliant contextual information based on at least the second ranking of the data sources.

6. The method of claim 1, wherein performing the contextual information retrieval process comprises:
identifying data sources from the contextual information repository that are similar to the aggregate embedding based on similarity criteria;
ranking the data sources based on similarity to the aggregate embedding to obtain a ranking; and
selecting at least one data source to be used as the uninferencing compliant contextual information based on at least the ranking.

7. The method of claim 1, wherein servicing the prompt comprises:
obtaining, using the prompt and the uninferencing compliant contextual information, an ingest package for the generative AI model;
initiating generation of an output by the generative AI model using the ingest package; and
using the output to provide the computer-implemented services to the user.

8. The method of claim 7, wherein initiating generation of the output by the generative AI model comprises:
performing, using the second portion of the prompt, an un-inferencing process to obtain a temporarily updated instance of the generative AI model, the second portion of the prompt being ascribed a negative user ascribed value by the user, and the temporarily updated instance of the generative AI model being less influenced by the second portion than the generative AI model.

9. The method of claim 8, wherein performing the un-inferencing process comprises at least one action selected from a list of actions consisting of:
negating embeddings corresponding to the second portion of the prompt to obtain the temporarily updated instance of the generative AI model;
adding, based on the second portion of the prompt, a negation layer to an input layer of the generative AI model to obtain the temporarily updated instance of the generative AI model;
adding, based on the second portion of the prompt, the negation layer prior to an attention module of the generative AI model to obtain the temporarily updated instance of the generative AI model; and
adding, based on the second portion of the prompt, the negation layer to a hidden layer of the attention module to obtain the temporarily updated instance of the generative AI model.

10. The method of claim 1, wherein obtaining the prompt comprises:
obtaining, from the user, the prompt as part of a chat session via interactions between the user and a graphical user interface (GUI).

11. The method of claim 10, wherein a record of the chat session is displayed to the user via the GUI, the record of the chat session comprising the prompt and any outputs generated by the generative AI model during the chat session.

12. The method of claim 1, wherein the generative AI model is a large language model (LLM).

13. The method of claim 1, wherein the prompt comprises at least one type of data modality selected from a list of types of data modalities consisting of:
text;
image;
video; and
audio.

14. A non-transitory machine-readable medium having instructions stored therein, which when executed by a processor, cause the processor to perform operations for providing computer-implemented services using generative artificial intelligence (AI) models, the operations comprising:
obtaining, from a user, a prompt for a generative AI model of the generative AI models, the prompt comprising:
a first portion of the prompt, and
a second portion of the prompt;
performing, using at least the prompt, an embedding generation process to obtain an aggregated embedding, the aggregated embedding comprising an inference model-ingestible representation of the prompt based on user ascribed values for the first portion of the prompt and the second portion of the prompt;
performing, using the aggregated embedding and a contextual information repository, a contextual information retrieval process to obtain uninferencing compliant contextual information for the prompt; and
servicing the prompt using at least the uninferencing compliant contextual information and the generative AI model.

15. The non-transitory machine-readable medium of claim 14, wherein the first portion of the prompt is ascribed a positive user ascribed value by the user, and the second portion of the prompt is ascribed a negative user ascribed value by the user.

16. The non-transitory machine-readable medium of claim 15, wherein performing the embedding generation process comprises:
obtaining a positive embedding for the first portion of the prompt;
obtaining a negative embedding for the second portion of the prompt; and
using the positive embedding and the negative embedding to obtain the aggregated embedding.

17. The non-transitory machine-readable medium of claim 16, wherein obtaining the negative embedding for the second portion of the prompt comprises:
obtaining a second positive embedding for the second portion of the prompt; and
negating the second positive embedding to obtain the negative embedding.

18. A data processing system, comprising:
a processor; and
a memory coupled to the processor to store instructions, which when executed by the processor, cause the processor to perform operations for providing computer-implemented services using generative artificial intelligence (AI) models, the operations comprising:
obtaining, from a user, a prompt for a generative AI model of the generative AI models, the prompt comprising:
a first portion of the prompt, and
a second portion of the prompt;
performing, using at least the prompt, an embedding generation process to obtain an aggregated embedding, the aggregated embedding comprising an inference model-ingestible representation of the prompt based on user ascribed values for the first portion of the prompt and the second portion of the prompt;
performing, using the aggregated embedding and a contextual information repository, a contextual information retrieval process to obtain uninferencing compliant contextual information for the prompt; and
servicing the prompt using at least the uninferencing compliant contextual information and the generative AI model.

19. The data processing system of claim 18, wherein the first portion of the prompt is ascribed a positive user ascribed value by the user, and the second portion of the prompt is ascribed a negative user ascribed value by the user.

20. The data processing system of claim 19, wherein performing the embedding generation process comprises:
obtaining a positive embedding for the first portion of the prompt;
obtaining a negative embedding for the second portion of the prompt; and
using the positive embedding and the negative embedding to obtain the aggregated embedding.
